(19) United States
(12) Patent Application Publication
(10) Pub. No.: US 2026/0097440 A1
(43) Pub. Date: Apr. 9, 2026

(54) PIPE SLITTER

(71) Applicant: The Charles Machine Works, Inc., Perry, OK (US)

(72) Inventors: Walter George Thompson, Janesville, WI (US); Mark D. Randa, Oconomowoc, WI (US)

(21) Appl. No.: 19/416,813

(22) Filed: Dec. 11, 2025

Related U.S. Application Data
(63) Continuation of application No. 18/458,496, filed on Aug. 30, 2023, now Pat. No. 12,496,645.
(60) Provisional application No. 63/403,186, filed on Sep. 1, 2022.

(51) Int. Cl. B23D 21/02; B23D 21/14; F16L 1/038; F16L 55/165; F16L 55/18

(52) U.S. Cl. CPC B23D 21/02; B23D 21/14; F16L 1/038; F16L 55/1658; F16L 55/18

(57) ABSTRACT

A pipe slitter assembly for lead pipe. The slitter assembly is configured to be pulled by a cable which is disposed through several of the various components of the assembly. At the lead of the assembly is a slitter, having one and only one blade. The blade has an edge which is oriented at a right angle to the longitudinal axis of the cable. The edge is created by two adjoining walls meeting at an included angle of about 21 degrees. Behind the blade may be various adaptors, and an expander. The expander opens the slit pipe, such that a pipe puller may be used to pull a replacement pipe into the void created by the slitter assembly. The slit pipe may be removed or left in the subsurface around the newly introduced replacement pipe.

### SUMMARY

The present invention is directed to a kit. The kit comprises an expander, a jaw assembly, a cable, and a blade assembly. The jaw assembly has a tapered outer surface configured for engagement to an inner surface of the expander. The cable is configured to be attachable to the jaw assembly. The blade assembly comprises a hollow cylinder and one and only one blade extending from an outer surface of the hollow cylinder. The hollow cylinder has a longitudinal axis. The blade comprises an edge.

In another aspect, the invention is directed to a method for replacing an underground pipe. The method comprises placing a cable through the underground pipe and disposing the cable through a blade assembly and an expander. The blade assembly comprises a hollow cylinder and one and only one blade. The hollow cylinder defines a longitudinal axis and the blade comprises an edge which is perpendicular to the longitudinal axis. The method further comprises attaching the cable to one or more jaws within the expander, and, thereafter, pulling the cable through the underground pipe such that the edge slits the underground pipe.

In a third aspect, the invention is directed to a pipe slitter assembly for slitting a pipeline. The assembly comprises a cable and a blade assembly. The blade assembly is disposed about the cable. The blade assembly comprises a cylindrical segment surrounding the cable and axially aligned along a longitudinal axis and one and only one slitter blade. The one and only one slitter blade has an edge oriented at a right angle to the longitudinal axis. The edge of the blade has an included angle substantially equal to 21 degrees.

### BRIEF DESCRIPTION OF THE DRAWINGS

FIG. 1 is a side view of various elements of a kit, used to create a slitting assembly. The assembly is disposed on a cable, and has a shackle at its back (right) end for connection to a pipe puller. From front (left) to back (right) the elements are a blade assembly, cone, separation tube, expander, and a pipe puller.

FIG. 2 is a sectional side view of the elements of the kit of claim 1, where the blade assembly, cone, separation tube, and expander are disposed about a cable, and a pipe puller is attached to one end of the expander. A jaw assembly is shown about the cable, and within the expander assembly.

FIG. 3 is a side view of a blade assembly. A cable is shown disposed within the blade assembly, in dashed lines where the cable passes through the hollow cylinder of the blade assembly.

FIG. 4 is a top view of the blade assembly, with the width of the blade and included angle of the edge portion of the blade shown.

FIG. 5 is a top front side perspective view of the assembly of FIG. 1.

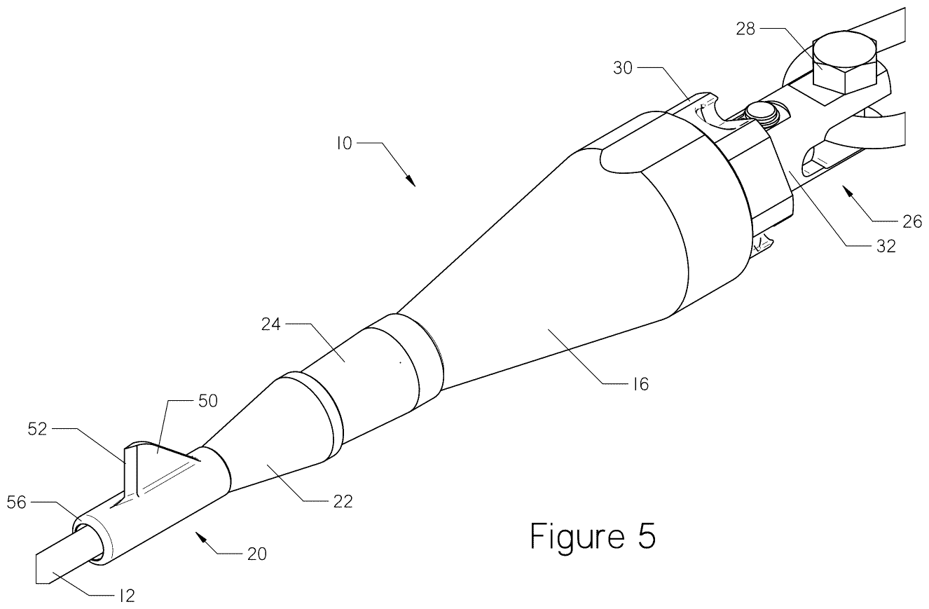

FIG. 6 is a side cross-sectional view of the assembly within an existing pipe. The existing pipe is slit by the slitter and expanded. A pipe puller pulls a new pipe into a void created by the expander.

### DETAILED DESCRIPTION

Pipe slitting is a process where an existing buried pipeline is separated longitudinally, expanded open circumferentially along with the surrounding soil and a new pipe is pulled in simultaneously as the slitting and expanding process is performed. Variations on the process include removal of the existing pipe prior to installation of the new (product) pipe; however many projects are performed with the slit host pipe remaining in the bore adjacent the product pipe.

A tensile structure such as a wire rope is pushed or fished through the host pipe and tooling capable of performing the combined slitting/pipe pulling process is attached to one end of the tensile pulling strand. A device capable of applying tension to the strand such as a hydraulic puller or even excavating equipment is coupled to the opposite end. One such pipe puller is disclosed in U.S. Patent Publ. No. 2021/0107074, Randa et al., the contents of which are incorporated herein by reference. A load is applied and the tooling is pulled along the path of the host pipe, through the ground.

Tooling arrangements utilizing slitters and expanders have been used to perform this replacement, such as in U.S. Pat. No. 9,566,653, issued to Randa et al., the contents of which are incorporated herein by reference. Such devices are often used for slitting PVC and other pipes, especially when such pipe is used to convey gas to a structure or dwelling.

However, the prior art does not provide an adequate solution to slitting and expanding (and replacing) lead pipe water lines. Lead pipe was commonly used in residential installations, and in recent years, the continued use of these pipes (even treated version) has been implicated in health issues for those consuming water conveyed in such pipes. Therefore, replacement, rather than coating or treatment, has often been seen as the best option for supplying water to structures with existing lead pipe supply.

Lead pipe water lines require several modifications to design and techniques related to such devices. Lead, being a very soft material, tends to deform about a slitter's blade. Such deformation may result in a blade passing through the deformed pipe, rather than fully slitting it. This deformation make subsequent installation of a replacement pipe more difficult. As a result, the slitter of the attached disclosure is used to overcome the limitations of current designs.

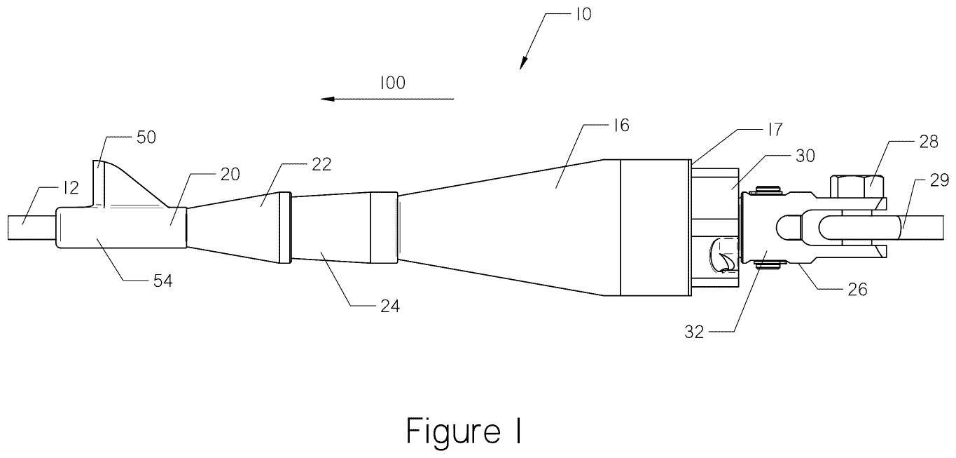

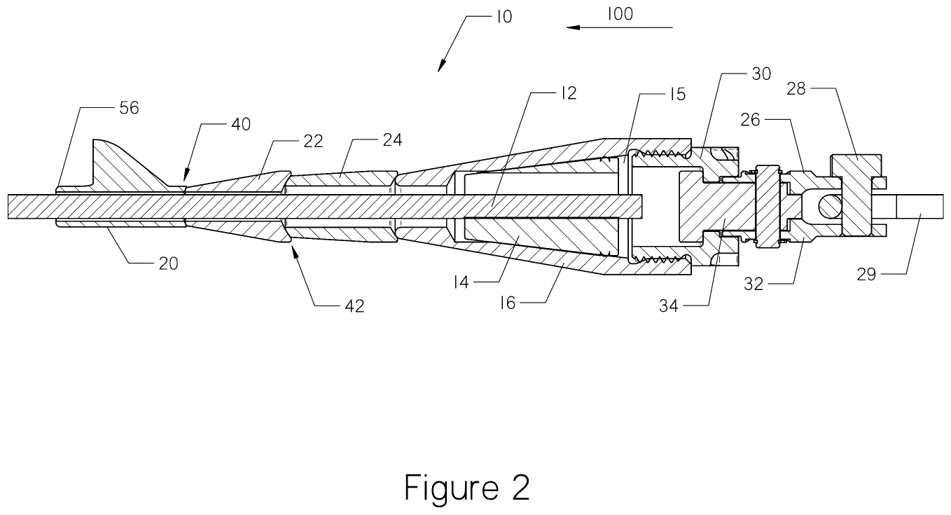

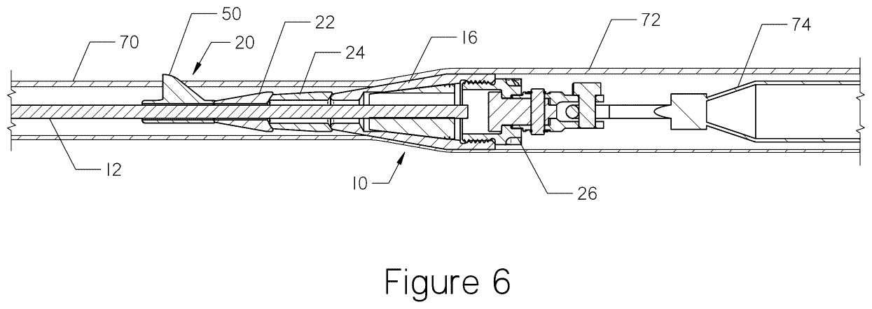

Turning now to FIGS. 1 and 2, a pipe slitter assembly 10 for use in slitting and replacing a pipeline 70 (FIG. 6), specifically a pipeline made of lead, is shown. The slitter assembly 10 is disposed about a cable 12, which extends through the assembly 10 and imparts a force upon it. Typically, the cable will be attached to the assembly through tapered jaws which are incorporated within a hollow region of one of the elements. As shown, the tapered jaws 14 are within a cavity 15 of an expander 16. As the cable 12 is pulled in direction 100, the jaws 14 are forced towards the smaller end of the cavity 15 of the expander 16, forcing them to grip the cable 12. In this way, the jaws tighten as the assembly 10 is being pulled through the existing pipe 70.

The slitter assembly 10 shown in FIGS. 1 and 2 comprises a blade assembly 20, a cone 22, a separation tube 24, and the expander 16. The expander 16 is at the back of the slitting apparatus 10 relative to the direction 100 in which the cable (and thus the assembly 10) is pulled through the pipe 70. After the pipe 70 is slit and forced around the larger outer diameter of the expander 16, it has a larger effective diameter with a void inside, characterized by portion 72 in FIG. 6.

A rear end 17 of the expander 16 is attached to a pipe puller 26. The pipe puller 26 may have a shackle 28 which allows the assembly to pivot relative to a replacement pipe 74. In addition, the pipe puller 26 may comprise a threaded first section 30 which is threaded to the expander 16, and a second section 32 attached to the first section 30 by a bolt 34. This bolt 34 may rotate within the first section 30 along the axis of the slitter assembly 10. The new pipe 74 is thus installed within the slit, expanded pipe 72 as the assembly 10 advances.

The shackle 28 allows for attachment to a second cable 29 which pulls new pipe (not shown) into the void created by the slitting assembly 10. Alternatively, the pipe puller 26 may be directly connected to the new pipe 74. If an existing pipe 70 is being slit without installation of a new pipe, the pipe puller is not necessary.

As shown in FIGS. 2 and 6, the cable 12 is disposed through a portion of the expander 16, as well as the length of each of the separation tube 24, cone 22, and blade assembly 20. Each of these elements cooperate with one another to slit and open the existing pipe 70. The blade assembly 20 cuts the pipe longitudinally. The blade assembly 20 chosen may have a small interface 40 for an abutting nose (such as a front end of the cone 22), as best seen in FIG. 2. The cone 22 operates as an adaptor between the blade assembly 20 and other elements, engaging at its rear end with a standard size interface 42 of the separation tube 24 or expander 16. The cone 22 thus allows smaller diameter blade assemblies 20 to be used, and cones 22 may be selected to engage with a particular blade assembly 20.

The separation tube 24 may be utilized in some applications of the slitter assembly 10. The length of the separation tube 24 spaces the expander 16 from the blade assembly 20. This separation may be important if, for example, the large diameter of the expander 16 would tend to cause deformation in the pipe 70 forward of the expander 16. Such deformation may be forced up the pipe (in direction 100) a region of the pipe which is in front of the blade assembly 10. This deformation may impact the ability of the blade assembly 10 to slit the pipe 70. By longitudinally displacing the expander 16 from the blade assembly 10, the expander 16 can open the inner diameter of a fully slit pipe 72 without impacting the slitting operation itself. The length of the separation tube 24 may vary depending upon the material of the existing pipe 70 and its diameter.

The expander 16 opens the slit existing pipe 70 enough that a replacement pipe 74 can be pulled behind by a pipe puller. In some scenarios, the expanded existing pipe 72 is left in the ground, with the replacement pipe 74 along the former path of the replaced and expanded pipe. Alternatively, the existing pipe may be pulled from the ground and disposed of appropriately.

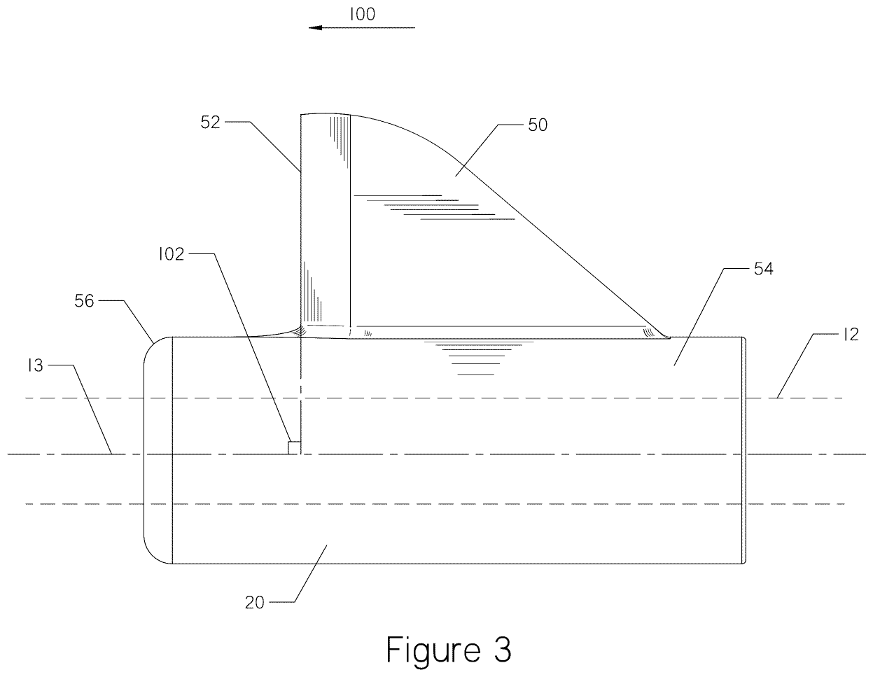

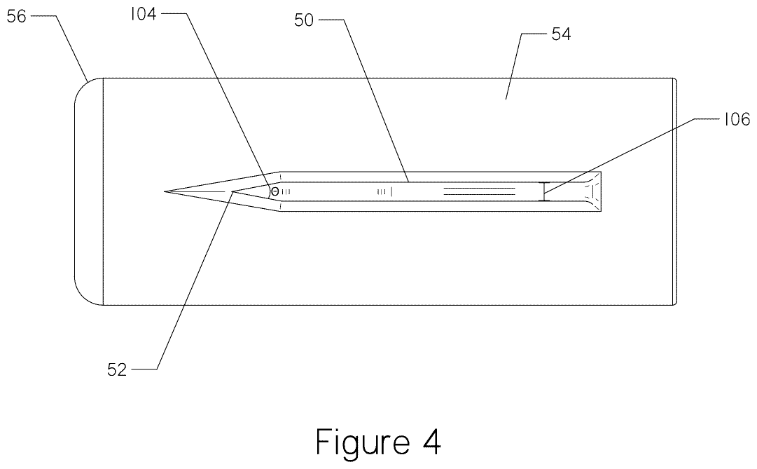

With reference to FIGS. 3-4, the blade assembly 20 is shown in detail. Unlike common slitters, which have a plurality of blades disposed about the perimeter of a cylindrical segment such that forces are distributed evenly on the existing pipe, the present blade has one, and only one, slitter blade 50 extending from a cylindrical segment 54. In addition, the one and only one slitter blade 50 has an edge 52 which is at a right angle 102 to the direction of travel 100 of the apparatus-that is, perpendicular to a longitudinal axis 13 of the cable 12 and the various portions of the slitting apparatus 10 that the cable 12 pulls.

The cylindrical segment 54 has a section which supports the blade 50, and a nose 56 extending about the cable 12 in front of the blade 50. This nose 56 is radiused to prevent the nose 56 from catching on a portion of the existing pipe. Further, its length prevents the slitting assembly 10 in general, and the blade 50 in particular, from angling relative to the pipe. Rather, the cable 12 (within the cylindrical segment 54) and the pipe (about the cylindrical segment 54 and in front of the blade 50) center the longitudinal axis 13 of the cable 12 along (or parallel to) the axis of the existing pipe.

In operation, the point of contact of the blade 50 with the existing pipe 70 is a line that is perpendicular to the pipe's longitudinal axis-situated at right angle 102. In this way, the entire thickness of the pipe 70, from inner diameter to outer diameter, is sliced at once, rather than gradually. Because the height of the edge 52, when added to the radius of the cylindrical segment 54 on which it is disposed, is greater than the outside radius of the existing pipe, the existing pipe 70 transitions from whole, to completely slit, all at once with reference to a position along the pipe's length. In lead pipe, or other soft pipe applications, such a complete slice is preferable to gradually slitting the pipe with a tapered blade. A tapered blade, as is known in the art, may be better for harder materials that are more difficult to cut but also less apt to deform. The blade 50 situated at right angle 102 prevents deformation and makes a clean slit of the existing pipe more likely.

The edge 52 of the blade 50 has an included angle 104, shown best in FIG. 4, substantially equal to 21 degrees. It should be understood that when “substantially equal” is used in the specification and claims, a tolerance of one degree is allowed-thus, an angle of 20 degrees would be substantially equal to 21 degrees, while 19 degrees will not. It is feasible for the included angle 104 to be as large as 24 degrees or as small as 18 degrees, though 21 degrees is preferred as discussed below.

Unlike other pipe materials, lead pipe is very soft, and prone to crushing. As a result, larger included angles for blades may cause the blade to push, rather than slice, the pipe. Too much force, without slicing, may cause the existing lead pipe to crush, forming an “accordion-like” structure, making further slitting of the existing pipe impossible. However, smaller included blades create long thin blade structures which may not fit properly on the cylindrical segment.

In addition, the maximum width 106 of the blade 50 may vary to meet the requirements of the existing pipe being slit. In practice, larger widths 106 make for stronger blades 50, but also may tend to crush the pipe. In addition, excessive opening of the pipe about the width 106 of the blade 50 may result in deformation of the pipe in front of the blade's edge 52. Therefore, the blade's maximum width 106 should be increased to accommodate thicker pipe wall and larger inner diameter pipe, while keeping the included angle 104 of the blade substantially equal to 21 degrees. Thus, larger width 106 blades 50 will have longer tapers from the edge to the maximum width.

Changes may be made in the construction, operation and arrangement of the various parts, elements, steps and procedures described herein without departing from the spirit and scope of the invention as described in the following claims.

1. A pipe slitting and expanding assembly, comprising:
an expander configured to spread a pipe; and
a blade assembly spaced longitudinally apart from the expander, the blade assembly comprising:
a hollow cylinder having a longitudinal axis; and
one and only one blade extending from an outer surface of the hollow cylinder, the blade comprising a linear cutting edge disposed at a right angle to the longitudinal axis of the hollow cylinder.

2. The assembly of claim 1, in which the expander comprises a front nose section, and wherein a pulling force is applied to the hollow cylinder by the front nose section of the expander.

3. The assembly of claim 1, further comprising a cable disposed through the expander and the hollow cylinder of the blade assembly.

4. The assembly of claim 1, further comprising a separation tube disposed between the expander and the hollow cylinder, wherein the separation tube is configured to longitudinally displace the expander from the blade assembly.

5. The assembly of claim 4, further comprising a cable, in which the separation tube, the blade assembly, and the expander are disposed about the cable.

6. The assembly of claim 5, further comprising a set of tapered jaws disposed about the cable, in which the tapered jaws are configured to engage an inner surface of the expander, such that the tapered jaws are configured to grip the cable when the cable is pulled through the expander in a direction of the blade assembly.

7. The assembly of claim 5, further comprising a pipe puller attached to the expander, wherein the pipe puller is configured to pull a replacement pipe behind the expander.

8. The assembly of claim 7, in which the cable is characterized as a first cable, in which the pipe puller comprises a shackle, and in which the shackle is attached to a second cable configured to pull the replacement pipe.

9. The assembly of claim 4, further comprising a cone disposed between the separation tube and the hollow cylinder of the blade assembly, wherein the cone engages an end of the hollow cylinder.

10. The assembly of claim 1, in which the hollow cylinder has a nose, wherein the nose is disposed at a terminal end of the hollow cylinder away from the expander, wherein the nose is radiused.

11. A method for replacing an underground pipe, comprising:
pulling a blade assembly through a pipe, the blade assembly comprising one and only one blade, such that the one and only one blade slits the pipe along a linear cutting edge, the linear cutting edge being perpendicular to the direction at which the blade assembly is pulled; and
simultaneously, pulling an expander through the pipe, such that the expander is spaced apart from the linear cutting edge of the blade assembly.

12. The method of claim 11, further comprising:
simultaneously, pulling a separation tube through the pipe, wherein the separation tube is disposed between the blade assembly and the expander.

13. The method of claim 12, further comprising:
simultaneously, pulling a cone through the pipe, wherein the cone has a first end configured to abut the separation tube and a second end configured to abut the blade assembly.

14. The method of claim 13, wherein the expander, separation tube, cone, and blade assembly are arranged in sequence about a cable, wherein the step of pulling the expander through the pipe is performed by the cable, and wherein pulling force is applied:
from the cable to the expander;
from the expander to the separation tube;
from the separation tube to the cone;
from the cone to the blade assembly; and
from the blade assembly to the underground pipe at the linear edge.

15. The method of claim 11, wherein the expander and blade assembly are arranged about a cable, and wherein a pulling force on the cable is applied to the expander through a pair of tapered jaws.

16. The method of claim 11, in which the linear cutting edge is formed by two opposing sides which meet at an included angle of 18 to 24 degrees.

17. A pipe slitter assembly for slitting a pipeline, comprising:
a blade assembly configured to be disposed about a cable, wherein the blade assembly comprises:
a cylindrical segment configured to surround the cable and axially align with the cable along a longitudinal axis; and
one and only one slitter blade extending from the cylindrical segment, the slitter blade having a linear cutting edge oriented at a right angle to the longitudinal axis, and wherein the edge of the blade is longitudinally spaced from a pipe expander when a pipe expander is disposed about the cable.

18. The pipe slitter assembly of claim 17, wherein the assembly further comprises a cable, and tapered jaws located within a cavity of the expander, the jaws configured to couple with the cable and to abut an inner surface of the pipe expander while coupled to the cable.

19. The pipe slitter assembly of claim 17, further comprising at least one element configured to increase a lateral distance between the pipe expander and the blade assembly.

20. The pipe slitter assembly of claim 17, further comprising at least one element configured to allow transmission of force between the pipe expander and the blade assembly.

21. The pipe slitter assembly of claim 17, further comprising at least one element configured to grip a cable when the at least one element abuts an inner surface of the pipe expander.

22. The pipe slitter assembly of claim 17, further comprising at least one element configured to pull a replacement pipe behind the pipe expander.
